(19) United States
(12) Patent Application Publication
(10) Pub. No.: US 2008/0051996 A1
(43) Pub. Date: Feb. 28, 2008

(54) APPARATUS AND METHOD FOR VEHICULAR DISPLAY OF INFORMATION

(76) Inventors: Katherine A. Dunning, Austin, TX (US); Michael Paolini, Austin, TX (US); Cristi N. Ullmann, Austin, TX (US)

Correspondence Address: CANTOR COLBURN LLP - IBM AUSTIN, 20 Church Street, 22nd Floor, Hartford, CT, 06103, US

(21) Appl. No.: 11/466,666

(22) Filed: Aug. 23, 2006

(51) Int. Cl. G01C 21/32

(52) U.S. Cl. 701/211; 701/1; 701/213

(57) ABSTRACT

A display system for a vehicle includes a transmissive display for mounting on a window of a vehicle, the display coupled to a processor for receiving input from at least one of a sensor from a plurality of sensors and a remote provider and for providing output to the display. A method for use of the display includes generating content and providing messages to the processor for providing display.

### TRADEMARKS

IBM® is registered trademark of International Business Machines Corporation, Armonk, N.Y., U.S.A. Other names used herein may be registered trademarks, trademarks or product names of international business Machines Corporation or other companies.

### BACKGROUND OF THE INVENTION

1. Field of the Invention

This invention relates to techniques for information messaging and particularly to vehicular based displays of information.

2. Description of the Related Art

Communicating and getting messages the populous in general is difficult. When a child is abducted, a vehicle stolen, or an emergency event is occurring, the existing notification systems may not provide effective notice to the general population, or more importantly to people in the vicinity of the event of interest. Consider the case of an abducted child.

In the cases of Amber alerts, which are issued in many jurisdictions to aid in the recovery of abduction victims, it is recognized that many cities don't participate in the Amber alert system. For those that do, many resources for notification are of limited value. For example, if a radio or a television is turned off, a message provided via radio or television broadcast is not delivered.

Concurrently, there is an excess of signage in the environment. For example, it is well known that some states have outlawed billboard signs on roadways. Further, it is also known that individuals can become desensitized or “sigil-blind” as a result of an excess of signs. At the same time, the development of many electronics products has provided improvements in communications technology.

What are needed are communications systems for providing effective emergency and similar notifications. Preferably, the communications systems make use of emerging technologies and provide for high visibility when needed.

### SUMMARY OF THE INVENTION

The shortcomings of the prior art are overcome and additional advantages are provided through the provision of a display system for a vehicle, the system including: a transmissive display for mounting on a window of a vehicle, the display coupled to a processor for receiving input from at least one of a sensor from a plurality of sensors and a remote provider and for providing output to the display.

Also disclosed is method for providing content, the method including: at least one of generating content and selecting stored content to provide a message; transmitting the message to a processor for receiving the message and providing the message to a flexible transmissive display mounted on a window of a vehicle; and displaying the message as content.

Further disclosed is a display system for a vehicle, the system including: a transmissive flexible transistor display for mounting on a window of a vehicle, the display coupled to a processor for receiving input from at least one of a sensor from a plurality of sensors and a remote provider and for providing output to the display; wherein the plurality of sensors comprise sensors for monitoring at least one of radiofrequency identification (RFID) tags, security of locks, security of closures, security of ignition, fluids, operational parameters, an alarm system, a proximity sensor including at least one of a laser range finder and a sonar range finder, a registration status, a license status, a parking status, a time of day, a date and a global positioning system (GPS); wherein the remote provider provides at least one of content and a trigger for selecting content from the processor.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of vehicle carrying signage according to the teachings herein;

FIG. 2 illustrates one example of a system for providing displays on a window of a vehicle;

FIG. 3 illustrates an exemplary method for providing displays.

The detailed description explains the preferred embodiments of the invention, together with advantages and features, by way of example with reference to the drawings.

### DETAILED DESCRIPTION OF THE INVENTION

Referring to FIG. 1, there is shown a diagram of a motor vehicle 5 adorned with a display 10. In some embodiments, the display 10 is placed over at least one of the windows 9 of the vehicle 5. As the display 10 is transparent, occupants of the vehicle are able to see through the display 10 without any substantial perturbations to their vision. The display 10 provides content 4 for observers.

Exemplary display 10 are disclosed in the U.S. Patent Application Publication No. 20060113536, published on Jun. 1, 2006 and entitled “Display.” This application discloses an active matrix display comprising a light control device and a field effect transistor for driving the light control device. The active layer of the field effect transistor comprises an amorphous oxide. Another disclosure providing exemplary components for the display 10 are disclosed in the U.S. Patent Application Publication No. 20060113539, published on Jun. 1, 2006 and entitled “Field Effect Transistor.” This application discloses a novel field-effect transistor is provided which employs an amorphous oxide. In an embodiment, the transistor comprises an amorphous oxide layer containing electron carrier at a concentration less than 1E-18/cm³, and the gate-insulating layer is comprised of a first layer being in contact with the amorphous oxide and a second layer different from the first layer. The disclosure of U.S. Patent Application Publications No. 20060113536 and 20060113539 are incorporated herein by reference in their entirety. Other similar or suited display apparatus may be known or devised. These other display apparatus may at least one of replace and augment the exemplary embodiments. Accordingly, the foregoing embodiments are merely illustrative and not limiting of the teachings herein.

In various embodiments, the display 10 includes a flexible transistor display. The display 10 is transmissive and essentially provides for “see through” visibility when the display 10 is not in use.

Using the display 10 in a window 9 of the vehicle 5, various alerts and notifications can be displayed. Some of the notifications involve notifications from on-board systems of the vehicle 5, while others work in concert with remote systems.

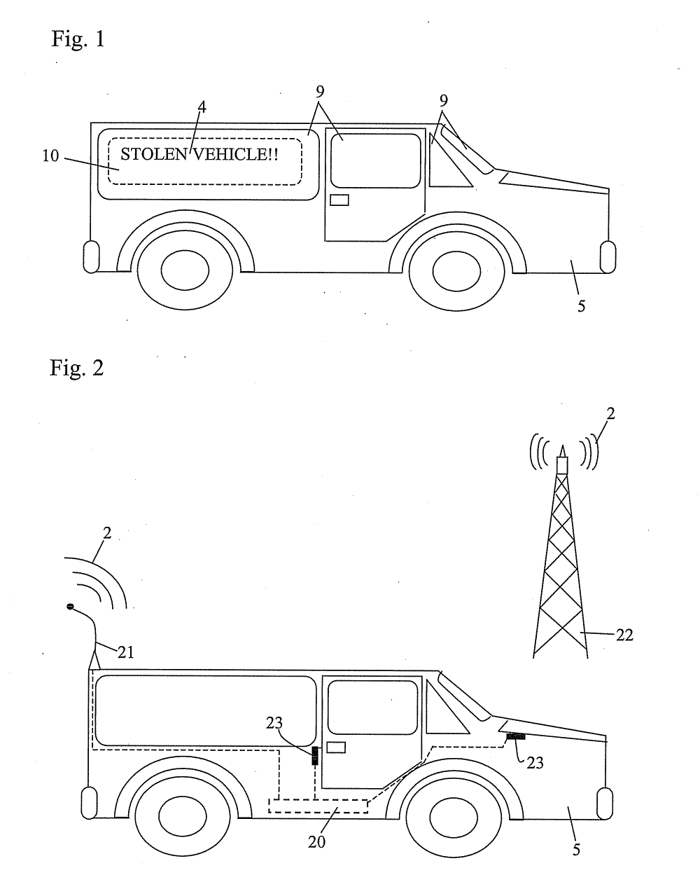

First, and with reference to FIG. 2, consider additional aspects of various embodiments of the vehicle 5. Some embodiments of the vehicle 5 are equipped with an antenna 21. Also included are a plurality of sensors 23, where each of the sensors monitors an aspect of the vehicle 5. Monitored aspects include, without limitation, security of locks, closures, and ignition, fluids, operational parameters such as speed, etc, . . . Other exemplary sensors 23 include those sensors that are known in the present art for monitoring vehicle functions. These prior art sensors are typically coupled to an on-board diagnostics (ODB) computer. Accordingly, the ODB may provide the processor 20 with content 4. In some embodiments, the information provided by the ODB is decoded to generate a message for display.

The sensors 23 include communication systems for communicating sensor information to a processor 20 on-board the vehicle 5. The various components discussed herein, such as the display 10, the processor 20, the plurality of sensors 23, the antenna 21 and other aspects as discussed herein and as might be known to those skilled in the art, provide for a system 29. The system 29 provides for generation of content 4 using the display 10.

Content 4 may include a variety of information conveyances. For example, the content 4 may include graphics, alphanumeric information, advertising, branding, alert information, signage, motion pictures, animation and other types of information as is known in the art. The content 4 may be combined with auditory content 4 (sound) as desired.

The processor 20 may include computer program products stored on machine readable media, where the products provide instructions for receiving communications with remote providers 22. The processor 20 includes other components as are known in the art. For example, the processor 20 may include a hard drive, memory, a user interface (such as various toggle switches for advancing or changing the display 10, in some embodiments a keyboard or word selection device), at least one communications port and other devices typically associated with computers. The processor 20 may include or communicate with a database including content 4. In some of these embodiments, access and use of the stored content 4 is actuated and controlled by the processor 20 in combination with instructions from the remote providers 22.

Typically, the communications are via a radiofrequency (RF) signal 2, such as the various RF signals 2 associated with a cellular communications network. In short, the display 10 may be used in conjunction with a variety of technologies.

For example, various on-board sensors 23 may be used to provide information to be displayed. In some embodiments, the processor 20 is used to provide communication with radiofrequency identification (RFID) tags (not shown) and other types of devices. The sensors 23 may be associated with any one or more of various components, internal to the vehicle 5, external to the vehicle 5 and combinations thereof. For example, internal to the vehicle 5, a registration document or plate may include the RFID tag and provide the processor 20 with registration information. External to the vehicle 5, and for example, other devices (such as laser range finders or sonar devices—not shown) may provide proximity information (such as to warn of curbs). Note that some embodiments may call for use of internal components and external components working together.

In some embodiments, such as those involving external input, the processor 20 receives information via the RF signal, wherein the information is provided by an outside party. In one embodiment, law enforcement sends a signal to the processor 20 turning on the display 10. The signal may contain content 4 for providing in the display 10 and may contain information for calling content 4 stored with the processor 20. Referring again to FIG. 1, some embodiments where external input (i.e., remote initiation) is used includes embodiments where it is desired to notify bystanders that the vehicle 5 is stolen.

Consider the case of an Amber alert for a missing or kidnapped child. In this case, an alert is broadcast, and parked cars (and other vehicles such public transportation buses, subways, taxis etc, . . . ) capable of receiving and displaying the alert post content 4 regarding the alert on respective displays 10. One advantage of this is to be able to show a picture of the missing child and other information (such as a car the child might be in, or a picture of the abductor) rapidly to a broad audience. In some embodiments, the broadcast is also received by vehicle equipped with the processor 20 and provided on other devices, such as a navigation screen inside of the vehicle 5.

Such alerts could be stored and cycled through. Windows 9 that do not effect the drivers ability to see or drive might be used while the vehicle 5 is in motion.

The system 29 would not be limited to Amber alerts, but could also be used to warn people of incoming storms and evacuations, of where to go during a storm, of stolen vehicles, or APB's for suspects. In some embodiments, users are provided with levels of use (access control), and may selectively defeat or permit certain types of content 4.

The system 29 may also be usable to notify of parking violations. For example, in some embodiments, if a parking meter expires, the system triggers the display 10 of the parked vehicle 5 to display “VIOLATION.” In some embodiments, fire hydrants and red zones or even handicap parking spaces similarly trigger the display 10. Various embodiments, make use of a challenge/response system—so that vehicles authorized to park in such locations would be able to do so without triggering the warnings. The warnings might start small, and grow over time. For example, in some embodiments, parking in a no parking zone causes the display 10 mounted for viewing from the interior of the vehicle 5 to show “no parking zone.” in some additional embodiments, the display 10 shifts to also show on the windows 9 after a specified period of time or upon actuation of some third party trigger. This would be helpful for streets for which allowed usage can change during time of day, or day of week. The system can be used to notify users of changes in policy in advance, for example street cleaning shifting from the posted sign to a different day due to a holiday.

The system 29 may also be tied into additional sensors 23 and broadcast systems. For example, in some embodiments, the display 10 is tied into an alarm system for the vehicle 5. If the alarm is activated, the display 10 provides an alert, such as flashing STOLEN or UNAUTHORIZED ACCESS or THIS IS A STOLEN CAR PLEASE CALL THE POLICE. In some embodiments, highly visible displays are provided, such as by use of a black background and yellow or red lettering. In some embodiments, the display 10 is turned to be as opaque as possible to prevent driving of the vehicle 5. In some embodiments, the display 10 is programmed for opaqueness just on a drivers side, while remaining windows 9 the rest transparent to add the identification of the thief. The messaging might continue with the display 10 in a semi-transparent state so that both the occupant and the message could be seen.

The system 29 may be used to display content 4 regarding other kinds of vehicle violations. For example, in some embodiments, expired registration tags or an expired safety inspection is displayed on the windows 9 while the vehicle 5 is parked. In other embodiments, messages are displayed on windows 9 which do not obscure the drivers view while the vehicle 5 is in motion. In places where vehicle access is controlled, such as Sao Paulo Brazil (cars with plates ending in certain numbers are not allowed in the city on certain days) GPS and other information may be combined to check for triggering of the system 29.

In embodiments where a driver's license is enabled for providing information (for example with RFID), the system 29 displays when a license is revoked, suspended, or not present. If the license has special characteristics, such as time of day, or location (e.g. not on highways), only with adult, etc, . . . the system 29 is invoked.

The system 29 may also be used to provide notice regarding other information such as an expired insurance policy. This may be triggered locally (for example, via an RFID tag associated with an insurance sticker by passing of certain date and information in local storage inside the vehicle or remotely by the insurance company). In some embodiments, this feature is active all the time, in other embodiments only when close to a police car.

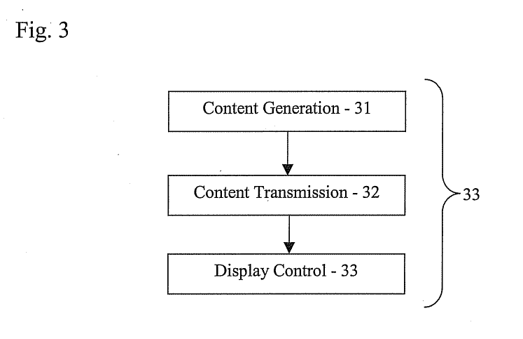

FIG. 3 depicts aspects of an exemplary method for use of the display. Referring to FIG. 3, an embodiment for displaying content 30 is provided. In a first step, content generation 31 is performed. Exemplary techniques for content generation 31 include create content 4, such as a picture or message using a computer, a cell phone, a personal digital assistant (PDA) or similar device. In some embodiments, content 4 is selected from the stored content 4 associated with the processor 20. The selected content 4 and the generated content 4 is then provided as a message for use in the display 10. Message transmission 32 occurs next. In message transmission 32, the content 4 is provided to the display 10. Message transmission 32 may involve intermediate steps such as broadcast to a server, with the server providing content 4 to a plurality of displays 10 (such as in some embodiments involving an Amber alert). Typically, message transmission 32 call for transmitting the content 4 to each display wirelessly, and relies upon information such as a unique IP address for each display 10. Typically, the display 10 can be automatically updated based on wireless communication (cell phone technology) as needed instantaneously. GPS location can also be used as a factor to update the display 10. In a third step, display control 33 is achieved. Display control 33 typically accounts for a variety of aspects of controlling the display 10, examples including changing the message, erasing the message and other such controlling. Clearly, some of these steps may and do overlap. For example, erasing content 4 may occur with the transmission of new content 4. Accordingly, the method provided is merely exemplary and not limiting of methods for using the teachings herein.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A display system for a vehicle, the system comprising:
a transmissive display for mounting on a window of a vehicle, the display coupled to a processor for receiving input from at least one of a sensor from a plurality of sensors and a remote provider and for providing output to the display.

2. The display system as in claim 1, wherein the transmissive display comprises a flexible transistor display.

3. The display system as in claim 1, wherein the plurality of sensors comprise sensors for monitoring at least one of radiofrequency identification (RFID) tags, security of locks, security of closures, security of ignition, fluids, operational parameters, an alarm system, a proximity sensor, a registration status, a license status, a parking status, a time of day, a date and a global positioning system (GPS).

4. The display system as in claim 3, wherein the proximity sensor comprises at least one of a laser range finder and a sonar range finder.

5. The display system as in claim 1, wherein the remote provider provides at least one of content and a trigger for selecting content from the processor.

6. The display system as in claim 1, further comprising means for communicating with the remote provider.

7. A method for providing content, the method comprising:
at least one of generating content and selecting stored content to provide a message;
transmitting the message to a processor for receiving the message and providing the message to a flexible transmissive display mounted on a window of a vehicle; and
displaying the message as content.

8. The method as in claim 7, wherein the content is at least one of locally generated and remotely generated.

9. The method as in claim 7, wherein generating content comprises providing sensor output information.

10. The method as in claim 7, wherein the content comprises information regarding at least one of:
an Amber alert, vehicle status, proximity status, stolen vehicle status, driver's license information, registration information, insurance information and parking status.

11. The method as in claim 7, wherein the message comprises instructions for changing the display to an opaque state.

12. The method as in claim 7, wherein the content comprises at least one of graphics, alphanumeric information, advertising, branding, alert information, signage, motion pictures and animation.

13. The method as in claim 7, wherein displaying further comprises providing sound with the content.

14. A display system for a vehicle, the system comprising:
a transmissive flexible transistor display for mounting on a window of a vehicle, the display coupled to a processor for receiving input from at least one of a sensor from a plurality of sensors and a remote provider and for providing output to the display;
wherein the plurality of sensors comprise sensors for monitoring at least one of radiofrequency identification (RFID) tags, security of locks, security of closures, security of ignition, fluids, operational parameters, an alarm system, a proximity sensor comprising at least one of a laser range finder and a sonar range finder, a registration status, a license status, a parking status, a time of day, a date and a global positioning system (GPS);
wherein the remote provider provides at least one of content and a trigger for selecting content from the processor.
